(19) United States
(12) Patent Application Publication
(10) Pub. No.: US 2011/0307230 A1
(43) Pub. Date: Dec. 15, 2011

(54) Optimizing Reservoir Performance Under Uncertainty

(76) Inventors: Li-Bong W. Lee, Houston, TX (US); Richard T. Mifflin, Houston, TX (US); Kevin C. Furman, Houston, TX (US); Vikas Goel, Houston, TX (US); Mark A. Rodriguez, Kingwood, TX (US)

(21) Appl. No.: 13/148,259

(22) PCT Filed: Dec. 14, 2009
(86) PCT No.: PCT/US09/67920

§ 371 Date: Aug. 5, 2011

Related U.S. Application Data
(60) Provisional application No. 61/157,836, filed on Mar. 5, 2009.

(51) Int. Cl. G06G 7/48

(52) U.S. Cl. 703/10

(57) ABSTRACT

One or more methods for optimizing reservoir development planning include a source of characterized input data, an optimization model, a baseline model for simulating the reservoir, a modified model, and one or more solution routines interfacing with the optimization model. The optimization model can consider unknown parameters having uncertainties directly within the optimization model. The modified model can systematically address uncertain data, for example comprehensively or even taking all uncertain data into account. Accordingly, the modified model is optimized to flexible or robust solutions. Final reservoir development plans are generated based on optimized model results.

### CROSS-REFERENCE TO RELATED APPLICATION

This application claims the benefit of U.S. Provisional Patent Application 61/157,836 filed Mar. 5, 2009 entitled OPTIMIZING RESERVOIR PERFORMANCE UNDER UNCERTAINTY, the entirety, of which is incorporated by reference herein.

### TECHNICAL FIELD

This description relates generally to oil and gas production, and more particularly to work processes for reservoir evaluation, reservoir management, and/or reservoir development planning taking uncertainty into consideration.

### BACKGROUND

Developing and managing petroleum resources often entails committing large economic investments over many years with an expectation of receiving correspondingly large financial returns. Whether a petroleum reservoir yields profit or loss depends largely upon the strategies and tactics implemented for reservoir development and management. Reservoir development planning involves devising and/or selecting strong strategies and tactics that will yield favorable economic results over the long term.

Reservoir development planning may include making decisions regarding size, timing, and location of facilities such as production platforms, wells, etc., as well as subsequent expansions and connections, for example. Key decisions can involve the number, location, allocation to platforms, and timing of wells to be drilled and completed in each field. Post drilling decisions may include determining production rate allocations across multiple wells. Any one decision or action may have system-wide implications, for example propagating positive or negative impact across a petroleum operation or a reservoir. In view of the aforementioned aspects of reservoir development planning, which are only a representative few of the many decisions facing a manager of petroleum resources, one can appreciate the value and impact of planning

Optimization of reservoir development planning and production can be affected by a number of factors. For instance, there exists uncertainty in reservoir behavior, economics, and/or other components of the development planning, and conventional reservoir development planning processes generally fail to consider uncertainty adequately.

Uncertainty is ordinarily inherent in the information and factors pertinent to development planning That is, the inputs to the optimization problem (including the mathematical modeling of the problem) nearly always contain uncertainty. Uncertainty can be viewed as characteristics or aspects that are nondeterministic or that otherwise remain unknown, a priori. Generally, there are two types of uncertainty, aleatoric uncertainty and epistemic uncertainty. Aleatoric uncertainties are uncertainties in which the value of a particular parameter is not known, but the parameter's probability distribution function (“PDF”) is known. Epistemic uncertainties are uncertainties caused by lack of qualitative information and are much more difficult to estimate. Such uncertainties can complicate the optimization of the work process surrounding reservoir development planning Conventional reservoir development planning processes often inadequately address aleatoric uncertainty. On the other hand, there are no systematic remedies for the failure to analyze, characterize, quantify, and model epistemic uncertainty adequately.

Uncertainty factors can enter into the reservoir modeling process in a number of ways. For instance, there are uncertainties in the data (“input”), such as rock types and the permeability map. There are also uncertainties in the models used to translate what is known about the reservoir into a numerical model, such as discretization or grid errors. In addition, there are human-factor uncertainties, which can impact the estimation of properties to be included in the model and the estimation of ranges, and probabilities associated with different uncertainties. Conventional work processes for reservoir development planning typically fail to address model and human-factor uncertainties.

Reservoir development planning processes may rely on Design of Experiments methodology to analyze and/or identify and then rank the importance of the top input uncertainty factors to different outcomes. Each uncertainty factor is assigned a value or level, such as high, medium, or low, or just high and low. A parameter space is designed based on the number of factors and number of levels for each factor. While the Design of Experiments methodology may reduce the number of runs or experiments associated with determining each factor's contribution to an outcome, this approach assumes a continuous or definable relationship between an outcome and the factors, and it will not estimate unconsidered uncertainties and can result in sub-optimal development decisions.

Another factor affecting the optimization of reservoir development planning is the decomposition of the representation of uncertainties in reservoir development plans. Analysis is required to determine the main components of uncertainty and their interdependencies, e.g., typically it is best to select components that minimize the interdependencies. The optimization process of reservoir development planning can be challenging, even under the assumption that the economics and behavior of reservoir and surface facilities are fully known. Typically, a large number of soft and hard constraints apply to an even larger number of decision variables. In practice, however, there exists uncertainty in reservoir behavior, economics, and/or other components of the decision process, which complicate the optimization process. Optimization of reservoir development planning or management strategy benefits from retaining a sufficiently detailed representation of the uncertainty during optimization.

Currently, considerations for uncertainty in reservoir behavior, economics, or other components of the decision process are typically reduced to a very limited number of cases, for example represented by a “high-side” case, a perceived “most-likely” or “mid” case, and a “low-side” case. For instance, the uncertainty in reservoir behavior is reduced to a known value, for each of the three cases mentioned above, by typically sampling random points within the uncertainty space in the reservoir, then selecting three instances that yield oil recoveries in the 90th percentile, 50th percentile and 10th percentile, respectively. The term “uncertainty space,” as used herein, generally refers to a representation of uncertainty relevant to a problem that is under solution, for example the collective uncertainties for data input to an optimization routine.

Based upon limited sampling of the uncertainty space, a value is assigned to the “high-side” case, the “most-likely” or “mid” case, and the “low-side” case. Decisions are usually optimized for a specific case, usually the perceived “most-likely” case, and subsequently evaluated for the remaining two cases to provide an estimate of the level of risk. This approach, however, often greatly underestimates the complexity of the uncertainty and can lead to a solution that is sub-optimal or that is less favorable than some other unidentified solution.

Yet another factor affecting the optimization of reservoir development planning is the computational limitations of conventional optimization technologies available. Conventional models are typically too simple for all but the most elementary cases, and the computed solution to the problem may be sub-optimal, or possibly even infeasible, especially if the model parameters are ultimately different than those parameters chosen to be used as input into the optimization model that is solved. While there have been improvements in computer speed and the performance of optimization methods, the computational cost of the technologies necessary to effect optimization under uncertainty is sufficiently high that the use of detailed models is not currently feasible in most cases.

Yet another component of the optimization of reservoir development planning involves the work processes that integrate the aforementioned uncertainty technologies together. Conventional methods typically do not consider the representation of uncertainty in the optimization process, and therefore do not effectively integrate the complexity of the system, the number of uncertainties affecting the decision, and the number of different developmental or operational considerations.

The terms “optimal,” “optimizing,” “optimize,” “optimality,” “optimization” (as well as derivatives and other forms of those terms and linguistically related words and phrases), as used herein, are not intended to be limiting in the sense of requiring the present invention to find the best solution or to make the best decision. Although a mathematically optimal solution may in fact arrive at the best of all mathematically available possibilities, real-world embodiments of optimization routines, methods, models, and processes may work towards such a goal without ever actually achieving perfection. Accordingly, one of ordinary skill in the art having benefit of the present disclosure will appreciate that these terms, in the context of the scope of the present invention, are more general. The terms can describe working towards a solution which may be the best available solution, a preferred solution, or a solution that offers a specific benefit within a range of constraints; or continually improving; or refining; or searching for a high point or a maximum for an objective; or processing to reduce a penalty function; etc.

In view of the foregoing discussion, need is apparent in the art for an improved work process that can aid reservoir development planning and/or that can provide decision support in connection with reservoir development and resource management. A need further exists for a work process that can effectively analyze, characterize, quantify, and model uncertainty associated with a reservoir. A need further exists for a work process that can retain a sufficiently detailed representation of the uncertainty while the development plan or management strategy is being optimized. A need further exists for a work process that can reduce the model to a manageable size, while retaining the critical features of the model. A need further exists for a work process that can integrate the complexity of the system, the number of uncertainties affecting the decision, and the number of different considerations for the plans or decision support. A need further exists for a work process that can help optimize the decisions related to the development plan or management strategy in the presence of uncertainty. The foregoing discussion of need in the art is intended to be representative rather than exhaustive. A technology addressing one or more such needs, or some other related shortcoming in the field, would benefit reservoir development planning, for example providing decisions or plans for developing and managing a reservoir more effectively and more profitably.

### SUMMARY

Aspects disclosed herein support making decisions, plans, strategies, and/or tactics for developing and managing petroleum resources, such as a petroleum reservoir. Specifically, one or more exemplary embodiments may be utilized to assist in reservoir evaluation, development planning, and/or reservoir management. For example, reservoir evaluation may include deciding appropriate bid amounts for properties based on an evaluation of the size and/or quality of the reservoir. Development planning may include deciding the size, timing, and/or location of surface facilities to build and/or install on site. Reservoir management may include deciding how to operate or manage the field, e.g., rate/pressure settings, wells to work over, and/or infill wells to drill. Intermediate applications of the aforementioned uses of reservoir evaluation, development planning, and/or reservoir management may include improved reservoir characterization (and any associated uncertainties), flow model history matching, and/or convincing prospective development partners with respect to proposed uses of technology.

In one general aspect, a method for optimizing reservoir performance for a reservoir containing hydrocarbons includes (a) identifying a reservoir related objective; (b) characterizing uncertainty contributing to the reservoir related objective, wherein characterizing uncertainty of the objective comprises determining decision variables and uncertainly variables associated with the objective; (c) analyzing the determined uncertainty variables and integrating the uncertainty variables with a baseline model related to the reservoir related objective to output a modified model incorporating uncertainty; (d) incorporating the determined decision variables with the modified model, and optimizing the decision variables to produce optimized model results; and (e) providing the optimized model results as feedback to the baseline model, wherein the optimized model results are compared with results output from the baseline model to determine convergence of results from each model or for reevaluating the baseline model.

Implementations of this aspect may include one or more of the following features. For example, the reservoir related objective may include one or more of an estimate of static reservoir characterization of the reservoir, a prediction of dynamic reservoir performance, and/or one or more scenarios relating to reservoir development planning The reservoir related objective may be associated with surface facilities related to the reservoir, subsurface equipment, resources and the reservoir, and/or both. Steps b) through e) may be iteratively repeated based on the optimized model results, e.g., as shown and described in connection with FIG. 1, if the results from the baseline model and the optimized model are not consistent. Analyzing the determined uncertainty variables may include using at least one of a response surface model, a probability distribution function model, and/or a combination thereof, to create at least one proxy model and/or at least one probability distribution function model which retains model performance and model characteristics in the modified model. The baseline model may include one or more relatively fine models and the modified model may include a larger number of relatively coarse models. The baseline model may be a high fidelity model, and the modified model may be a high speed (in terms of processing time) representation of the high fidelity model. The baseline model may be a high fidelity model and the modified model may be a lower fidelity representation of the high fidelity model.

The method may include obtaining input regarding a plurality of factors relevant to the reservoir related objective; based on the input, characterizing some of the plurality of factors as decision variables and other of the plurality of factors as uncertainty variables; and providing output relevant to completing the reservoir related objective in response to processing the decision variables and the uncertainty variables via a computer-based routine. The step of obtaining input may include conducting a Delphi method, including determining factors and ranges relevant to the reservoir development objective via the Delphi method. Obtaining input may include obtaining input from a panel of experts. The step of obtaining input may include obtaining an opinion from each expert from the panel of experts; and soliciting feedback from each of the experts regarding the obtained opinions, while maintaining anonymity of each obtained opinion. Processing the decision variables and the uncertainty variables via the computer-based routine comprises generating a response surface model or some other high-speed proxy model associated with the uncertainty variables via a design-of-experiment technique or other approach to defining the key uncertainties. Processing the decision variables and the uncertainty variables via the computer-based routine comprises generating a distribution function model or other representation associated with the uncertainty variables via Bayesian Belief Networks or another approach to interactions of the uncertainties.

Processing the decision variables and the uncertainty variables via the computer-based routine may include optimizing via computer-implemented robust optimization at least some aspect of a reservoir development plan based on at least one data parameter and an uncertainty space. Processing the decision variables and the uncertainty variables via the computer-based routine may include optimizing via stochastic programming. The computer-based routine may include optimizing via Markov decision process based optimization. A reservoir development plan may be formulated based on the optimized model results. Hydrocarbon resources may be developed from the reservoir according to the reservoir development plan.

In another general aspect, a method is provided for determining reservoir performance includes characterizing uncertainty related to reservoir development into decision variables and uncertainty variables based on input from a panel of experts; analyzing the uncertainty variables using a reservoir model to construct proxy models; and optimizing the decision variables and the proxy models via one or more of computer-implemented robust optimization, stochastic programming, and Markov decision process based optimization models.

Implementations of this aspect may include one or more of the following features. For example, bias of the panel of experts may be mitigated, e.g., by preserving anonymity of the input from each of the experts.

In one or more of the aforementioned aspects, a computer- or software-based method, process, or workflow can provide decision support in connection with developing one or more petroleum reservoirs. For example, an exemplary method can integrate various technologies associated with reservoir development planning In certain embodiments, uncertainty is characterized into data parameters using anonymous or Delphi techniques or methodologies. For example, the data parameters can comprise unknown or ill-defined fluid dynamics, the size of the reservoir, the current state of development, current and projected prices of petroleum, drilling costs, cost per hour of rig time, geological data, the cost of capital, current and projected available resources (human, financial, equipment, etc.), and the regulatory environment, to name a few representative possibilities. Each data parameter can have uncertainty. More specifically, each element of the data parameters can have an associated level, amount, or indication of uncertainty. Some of the data parameters may be known with a high level of certainty, such as the current cost of rig time, while other input data may have various degrees of uncertainty. For example, uncertainty of future rig time cost will typically increase as the amount of time projected into the future increases or with increases in the price of oil. Therefore, the uncertainty of rig time cost for the fifth year of the development plan would likely be higher than the uncertainty of rig time cost for the second year.

The collective uncertainties of the data parameters can define an uncertainty space. A software routine can produce the reservoir development plan via processing the data parameters and taking the uncertainty space into consideration, for example via applying a robust optimization routine or a stochastic programming-based routine or a Markov decision process-based method. Producing the reservoir development plan can comprise outputting some aspect of a plan, making a determination relevant to generating or changing a plan, or making a recommendation about one or more decisions relevant to reservoir development or management, for example.

The discussion of decision support tools for reservoir development presented in this summary is for illustrative purposes only. Various aspects may be more clearly understood and appreciated from a review of the following detailed description of the disclosed embodiments and by reference to the drawings and the claims that follow. Moreover, other aspects, systems, methods, features, advantages, and objects will become apparent to one with skill in the art upon examination of the following drawings and detailed description. It is intended that all such aspects, systems, methods, features, advantages, and objects are to be included within this description, are to be within the scope of the disclosure, and are to be protected by the accompanying claims.

### BRIEF DESCRIPTION OF THE DRAWINGS

FIG. 1 is a flowchart illustration of a method for optimization of reservoir development planning, reservoir evaluation, and/or reservoir management in accordance with certain exemplary embodiments.

FIG. 2 is a graphical illustration representing the use of an entire uncertainty space associated with data for robust optimization of a reservoir model in accordance with certain exemplary embodiments.

FIG. 3 is an illustration of a multistage stochastic programming decision tree representing uncertainty associated with data for a reservoir model resolved in several steps and the resolution of the uncertainty over time in accordance with certain exemplary embodiments.

FIG. 4 is an illustration of a Markov decision process-based method representing uncertainty associated with data for a reservoir model resolved in several steps and the resolution of the uncertainty over time in accordance with certain exemplary embodiments.

FIG. 5 is a schematic view of an exemplary system for soliciting input from a panel of experts through a recorder and a facilitator within a virtual Delphi environment.

FIG. 6 is an exemplary screenshot of a whiteboard view from a facilitator's perspective within a virtual Delphi environment.

FIG. 7 is an exemplary screenshot of a whiteboard view from a participant's perspective within a virtual Delphi environment.

Many aspects of the embodiments can be better understood with reference to the above drawings. The elements and features shown in the drawings are not necessarily to scale, emphasis instead being placed upon clearly illustrating principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION

One or more exemplary embodiments support work processes that integrate analysis and characterization of uncertainty associated with a reservoir with making decisions in reservoir development planning, reservoir evaluation, and/or reservoir management. Such a paradigm enables significantly superior decisions to be made.

The disclosed aspects can be embodied in many different forms and should not be construed as limited to the embodiments set forth herein; rather, these embodiments are provided so that this disclosure will be thorough and complete, and will fully convey the scope of the disclosure to those having ordinary skill in the art. Furthermore, all “examples” or “exemplary embodiments” given herein are intended to be non-limiting, and among others supported by representations of the disclosure.

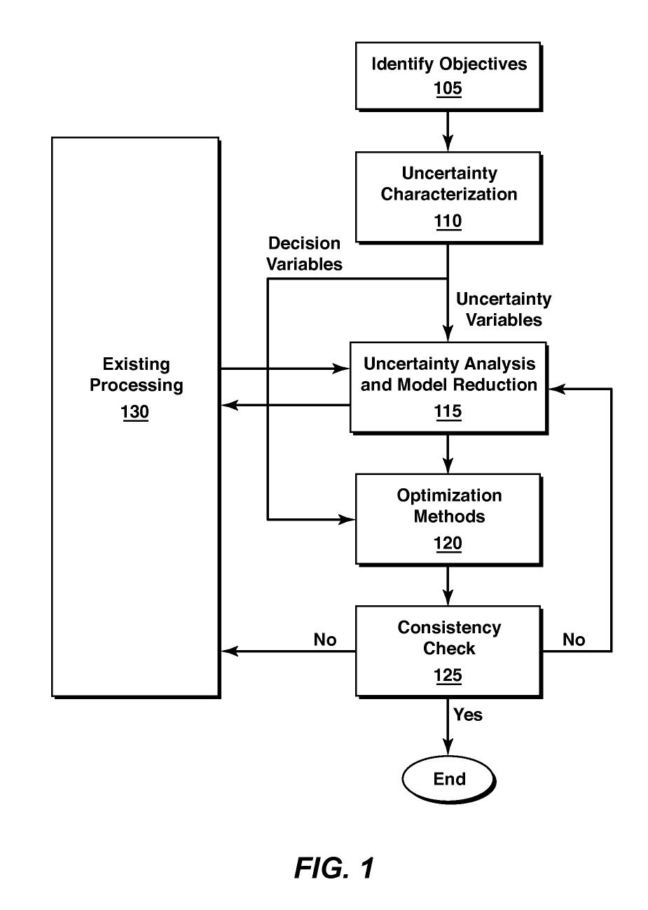

An exemplary embodiment will now be described in detail with reference to FIG. 1. FIG. 1 is a flowchart illustration of a method 100 for optimizing reservoir performance under uncertainty.

Certain steps in the methods and processes described herein must naturally precede others for one or more of the exemplary embodiments to function as described. However, the exemplary embodiments are not limited to the order of the steps described if such order or sequence does not adversely alter the functionality of the described method or process. That is, it is recognized that some steps may be performed before or after other steps or in parallel with other steps without departing from the scope and spirit of the disclsoure.

One or more of the following embodiments can include multiple processes that can be implemented with computer and/or manual operation. One or more of the following embodiments can comprise one or more computer programs that embody certain functions described herein and illustrated in the examples, diagrams, figures, and flowcharts. However, it should be apparent that there could be many different ways of implementing disclosed aspects with computer programming, manually, non-computer-based machines, or in a combination of computer and manual implementation. The embodiments described hereinafter should not be construed as limited to any one set of computer program instructions. Further, a programmer with ordinary skill would be able to write such computer programs without difficulty or undue experimentation based on the disclosure and teaching presented herein.

Therefore, disclosure of a particular set of program code instructions is not considered necessary for an adequate understanding of how to make and use the exemplary embodiments. The functionality of any programming aspects of the exemplary embodiments will be explained in further detail in the following description in conjunction with the figures illustrating the functions and program flow and processes.

Referring to FIG. 1, an exemplary process 100 begins with step 105. At step 105, the objective of the study is identified, e.g., a reservoir related objective. In certain exemplary embodiments, the objective of the study may be to estimate static reservoir characterization, predict dynamic reservoir performance, or develop potential scenarios related to development planning The objective of the study will determine the extent of details included in the modeling processes.

Step 105 proceeds to step 110. At step 110, the uncertainty is characterized. In certain embodiments, the key uncertainty factor is the size of the reservoir. In alternative embodiments, a number of factors can impact the decisions. Uncertainty may be characterized by a number of exemplary techniques. For example, uncertainty may be characterized by gathering expert opinion to identify factors, their ranges, and their distributions in such a manner as to minimize potential biases. In addition to conventional methods of characterizing uncertainty, step 110 recognizes that human factors also may play a role in uncertainty characterization.

In another exemplary embodiment, step 110 utilizes the Delphi method to address the human factors. A “virtual” Delphi method systematically gathers expert opinion through an interactive arena, while maintaining the anonymous aspect of the Delphi method. A panel facilitator provides to the group of experts the anonymous opinion for each individual and the reasons for their decision. Each expert may revise their opinion in light of the information provided by the panel facilitator. After a number of sessions or achievement of consensus, the process ends and the factors' importance are determined based on mean or median scores while factor ranges are based on consensus. The factors identified are then classified as decision variables, e.g., factors that can be controlled through choices made, or uncertainty variables, e.g., factors associated with the state of nature but there is insufficient knowledge to know what it is.

The uncertainty variables determined from step 110 are input into step 115. In step 115, the uncertainty variables are analyzed using existing or specially constructed reservoir models. The dimensions of the reservoir models often must be reduced substantially in order to make the optimization process numerically tractable. In some embodiments, the uncertainty variables in step 115 may be analyzed using a high-speed model that is computationally efficient and provides an approximation of the reservoir and surface facility behavior. The high-speed model provides less computational precision than conventional high fidelity models used, and produces relatively rough results and thus executes much faster on a typical computing system. The high-speed model may be generated from a portion of the software code used in a high fidelity model for reservoir and/or surface facility behavior. For example, the software of the high fidelity model can be tuned so as to run faster, but with less accuracy. A high fidelity model can be adapted or configured to provide a high-speed model via reducing the number of parameter inputs, via specifying larger cell sizes, etc.

Suitable examples of models for uncertainty variable analysis include, but are not limited to, response surface models, probability distribution function (PDF) models, and combinations thereof. Response surface models may be constructed through design-of-experiment techniques or Latin hypercube sampling. Distribution function models may be built using Bayesian Belief Networks (BBNs) or other methods for representing an unknown variable as a probability distribution, such as the polynomial chaos expansion. Analysis of the uncertainty variables results in proxy models and PDFs which retain the performance and characteristics of the model. The term “proxy model,” as used herein, generally refers to a regression for developing a relationship between a decision and one or more uncertainty variables.

The decision variables determined from step 110 and the proxy models and PDF's determined from step 115 are input into step 120. At step 120, the decision variables are optimized. By incorporating the uncertainty in the data into the optimization model, tradeoffs associated with decisions across various realizations of the uncertainty are captured and hence, better information is available when making decisions regarding petroleum and/or natural gas reservoir development planning Suitable examples of optimization methods include, but are not limited to, robust optimization, stochastic programming and Markov decision process (also known as Stochastic Dynamic Programming) methods. Alternatively, step 120 could involve solving a deterministic optimization model, where the uncertainty is reduced to a single point estimate, and evaluating the performance of the resulting solution over the entire uncertainty space.

In certain embodiments, the optimization method of step 120 is robust optimization. Robust optimization for reservoir development planning can include one or more robust optimization models that may, for example, be of a linear programming problem, or a nonlinear programming problem, or a mixed integer linear programming problem or a mixed integer nonlinear programming problem form. Robust optimization for reservoir development planning could also include one or more fit-for-purpose solution routines or algorithms for the solution of these models. The fit-for-purpose solution routines may include a combination of commercial or openly available mathematical programming solver routines and specially designed model-specific techniques. Solving the robust optimization model for reservoir development planning can be achieved without PDFs for the uncertainty representation.

The aim of such robust optimization is to choose a solution which is able to cope best with various realizations of uncertain data. The uncertain data is assumed to be unknown but bounded, and theoretical results may also assume convexity of the uncertainty space. The optimization problem with uncertain parameters is reformulated into a counterpart robust optimization problem. In this case, in addition to known or certain data parameters, there are also uncertain data parameters θ (theta) appearing in the constraints. The constraints are reformulated such that they must be satisfied given any possible realization of the uncertain parameters. The decision variable arrays “x” and “y” are now also posed such that they are dependent on the realizations of the uncertain parameters.
min f(x,y)
s.t. g(x, y; θ)≦0 ∀ θ ε {uncertainty space}
   x ε X
   y(θ) ε Y

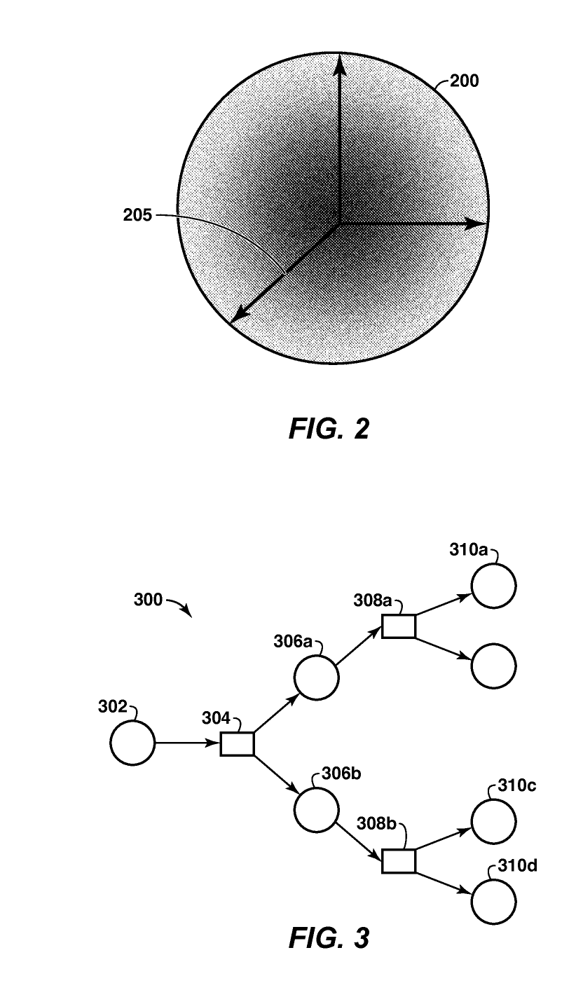

According to an exemplary embodiment, robust optimization ensures (or alternatively provides or supports) robustness and flexibility in an optimization solution by forcing feasibility of an optimization problem for the entire given uncertainty space, for example essentially covering the uncertainty space as described with respect to FIG. 2. Referring to FIG. 2, an entire uncertainty space 200 is associated with data for robust optimization of a reservoir model in accordance with certain exemplary embodiments of the present invention. Three axes 205 are depicted which each represent any three uncertainty variables, e.g., normally distributed. The shading represents various probabilities, e.g., a probability distribution. However, the uncertainty space 200 may include any number of variables and/or any number of probability distributions. Solutions avoid violating (or do not violate) any constraint for any data realization. Furthermore, robust optimization allows mitigation of the worst-case scenario given.

In certain embodiments, the optimization method of step 120 is a recourse based optimization model. As used herein, the term “recourse” refers to the ability to take corrective action after information has been received. An exemplary recourse based optimization model systematically addresses all the uncertain data and its evolution over time. Such a recourse based optimization model incorporates the uncertainty representation in the optimization model and evaluates solution performance explicitly over all scenarios. Further, the recourse based optimization model can incorporate the flexibility that the decision-maker has in the real world to adjust decisions based on new information obtained over time. The decision-maker will be able to make corrective decisions/actions based upon this new information. Such a paradigm allows for producing flexible or robust solutions that remain feasible covering the uncertainty space, as well as making the trade-off between optimality and the uncertainty in the input data to reflect the risk attitude of a decision-maker.

The recourse based optimization model may include long term planning of investment, production, or development, in which fixed decisions occur in stages over time. Therefore, opportunities are created to consider more definite information as time passes. Decisions in the model may also include decisions that correspond to actions that may recover information about the uncertainties. With recourse leading to robust, flexible, higher value decisions and a realistic model of decision-making in the real world, the recourse based optimization model can provide better solutions.

In some embodiments, the recourse based optimization model may be stochastic programming. In certain exemplary embodiments, stochastic programming provides an approach to reservoir development planning and handles uncertainty effectively, as described further with respect to FIG. 3. In some embodiments, the framework may be analogous to a robust optimization model. However, the penalty function in the objective may replace feasibility for all realizations deemed possible, sometimes referred to as “scenarios.” One exemplary embodiment of stochastic programming takes advantage of the property that probability distributions governing reservoir development planning data are usually either known or can be estimated. In some embodiments, the stochastic programming model may be utilized to find a policy that is feasible for all, or nearly all, possible data instances, as well as that maximizes the expectation of some function of the decisions and random variables.

In some embodiments, a multistage stochastic programming-based method is used. In some embodiments, the stochastic programming-based method may further include the addition of probabilistic or chance constraints, expected value constraints, and/or measures of risk in the objective of the optimization model. Generally, the stochastic programming-based method may be solved analytically or numerically, and analyzed in order to provide useful information to the decision-maker. In some exemplary embodiments, the stochastic programming-based method includes a two-stage model or linear program, which is a particular embodiment of the multistage stochastic programming-based method. In such embodiments, the decision-maker takes some action during a first stage, after which information is received pertaining to the outcome of the first stage decision. Thereafter, a recourse decision can be made in a second stage that compensates for any negative effects that may have been experienced as a result of the first stage decision. The two-stage stochastic programming-based method aims to optimize the expected value of the objective function subject to constraints with the uncertainty resolving at one point in the time horizon. The optimal policy from such a model is a single first stage policy and a collection of recourse decisions, sometimes referred to “a decision rule”, defining which second stage action should be taken in response to each outcome. Two mathematical formulations for a two-stage model are as follows:

$$min {E}_{θ} [ f ( x , y ; θ ] -> min {\sum }_{s} {p}_{s} f ( x , {y}_{s} ; {θ}_{s} ) s ∈ \{ samples / scenarios \} \\ s . t . g ( x , y ; θ ) \leq 0 s . t . g ( x , {y}_{s} ; {θ}_{s} ) \leq 0$$

According to an exemplary embodiment, the application of the two-stage stochastic programming-based method may be in chemical process design. Uncertainty may occur in the exact composition, properties, and amount of raw materials. First stage decisions may include design decisions such as the type of process units to be installed and the design specifications of the selected units. Second stage decisions may include operations decisions, for instance, flow rates and temperatures that may be controlled to adjust to specific realizations of the uncertain data.

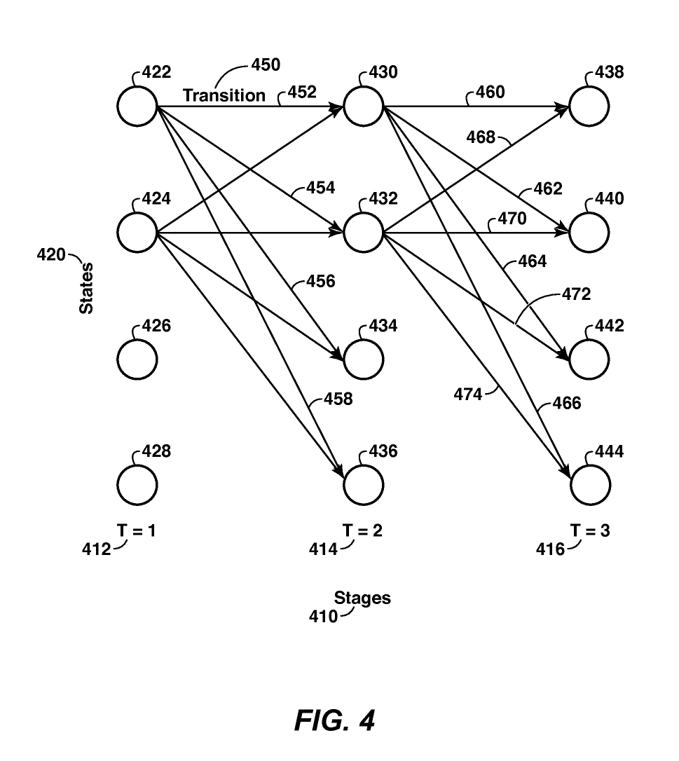

In some embodiments, the recourse based optimization model may be a Markov decision process-based method. This method readily incorporates black box functions for state equations and allows complex conditional transition probabilities to be used. One exemplary embodiment of Markov decision process-based modeling takes advantage of the fact that probability distributions governing reservoir development planning data are known or can be estimated. In some embodiments, the Markov decision process-based modeling may be utilized to find a policy that is feasible for all, or nearly all, possible data instances, as well as maximizes the expectation of some function of the decisions and random variables, as described with respect to FIG. 4.

The results from solving the optimization model of step 120 proceed to step 125. At step 125, the results from step 120 are reviewed to ensure consistency and to check that the various models have retained the key features identified in step 105. Causal relationships between knowns (or narrowed unknowns) and unknowns and the distributions of the results, as identified by step 115, are checked for consistency. If the review process determines that the objective is not met, or that the results are inconsistent, the results from step 120 may be input into step 115 and the model may be updated to produce another set of proxy models to be optimized. This iteration may be repeated until the objective of the study is satisfied and the results check for consistency.

The method 100 also includes step 130. Step 130 includes processes that develop data, models, and business information. In certain embodiments, those processes include one or more high fidelity models for reservoir and/or surface facility behavior that includes one or more reservoir or surface facility simulators. For instance, the reservoir simulator can comprise or be based upon software-based tools, programs, or capabilities; such as those marketed by: Schlumberger Technology Corporation under the registered trademark “ECLIPSE”, Landmark Graphics Corporation under the registered trademark “VIP”, or Landmark Graphics Corporation under the registered trademark “NEXUS”. Also, the processes of step 130 may comprise one or more routines, methods, processes, or algorithms for solving the models for reservoir development planning

The processes of Step 130 can be adapted to interact with the results from steps 110, 115, 120, and 125. Step 130 compares with results of the optimization and is continuously updated based on the processes of steps 115, 120, and 125. Several iterative loops exist to check the results of the different processes. In certain exemplary embodiments, the iterations are primarily automated, with the user team guiding the process and “tweaking” parameters as needed.

In certain exemplary embodiments, the reservoir and/or surface facility parameter input data, generated by the optimization method of step 120, is optionally provided to the high fidelity model(s) of step 130. The high fidelity model is used to simulate the reservoir and/or surface facilities under these conditions. This simulation generates a corresponding high fidelity output data, which may also be referred to as the reservoir and/or surface facility property input data. A determination is then made as to whether the output of the high fidelity model(s) is(are) substantially consistent with the prediction from step 120. If the components are not substantially consistent, the reservoir and/or surface facility property input data is again provided to step 115. The components are again generated for optimization and the model is again solved. This process continues to iterate until the output of the high fidelity model(s) at step 130 is(are) substantially consistent with the prediction from step 120. For example, when the results of the high fidelity model and from step 120 converge, step 125 can make a determination that a sufficient level of processing has been completed. At that point, step 125 deems the iterating complete.

Once the prediction from step 120 is consistent with the output of the high fidelity model(s) of step 130, the model for optimization is again solved to generate an output which may include a final development plan at step 125. The output may be used to generate reports, calculations, tables, figures, charts, etc. for the analysis of development planning or reservoir management under data uncertainty. Moreover, exemplary embodiments of the output may comprise a result displayed on a graphical user interface (GUI), a data file, data on a medium such as an optical or magnetic disk, a paper report, or signals transmitted to another computer or another software routine, or some other tangible output to name a few examples.

An exemplary application of the aforementioned process 100 and/or one or more suggested variations thereof may include an offshore field with five or more hydrocarbon reservoirs. The sizes and producibilities of the reservoirs can be roughly estimated based on seismic data, geological information, and discovery wells in the five reservoirs. The exemplary field is to be developed using from one to three Floating Production, Storage, and Offloading (FPSO) vessels, subsea templates, and connections between the templates and the FPSOs. For an additional cost, the FPSOs can be designed to allow for incremental expansions. Step 105 may include choosing a development planning approach, e.g., platform versus FPSO. For example, the objective (step 105) may be to optimize the expected net present value (ENPV) of the total field over its life through the selection of the sizes of the FPSOs and selection of the field connections. Uncertainties are determined (step 110) not only for the rates and overall recoveries of each discovered reservoir but also for the possibility there are other hydrocarbon reservoirs. Exemplary uncertainty variables may include field size, water-oil contact locations, and/or fractional fault seal, and exemplary decision variables may include the size of the FPSOs, and/or the number of wells in each field. For this case, the models are reduced (step 115) to simple type curves that do not represent interwell interactions. For example, field models that were originally created in reservoir simulation software, such as Eclipse by Schlumberger, are reduced to response surfaces that model the oil production as a function of the uncertainty variables. For decisions concerning the wells to be drilled in each field, such models would be needed. Using Stochastic Programming as the optimizer (step 120) in this case, a development plan with two FPSOs and their connections, with increments that depend on information obtained from early production data is found to be optimal. For example, using a decision arrived at in step 120, detailed reservoir and facility models are constructed, cases for a selected set of realizations of the uncertainties are ran, and the exemplary constistency check is whether the decision (from step 120) meets standard criteria, e.g., net present value, and/ sensitivity to the uncertainties. This development plan is optionally checked against existing, detailed, individual deterministic (most-likely case) field models (from step 130) to ensure that the base plan is consistent (step 125). For example, some exemplary system processes (step 130) include collection of field data, development of an asset-level business plan, development of geological models, and/or development of reservoir flow models. The development plan may then be sent on for front-end engineering and design.

According to some embodiments, multiple cases may be tested and optimized so that their results may be compared side-by-side as part of the process. As a result, the integration of the processes of step 130 with the uncertainty characterization of step 110, uncertainty analysis of step 115, and optimization routine of step 120, will support making significantly superior decisions with regard to development planning and reservoir management as compared to the status quo.

In various exemplary embodiments, portions of method 100 can be implemented using a mathematical programming language or system, for example AIMMS, GAMS, AMPL, OPL, Mosel, etc.; or using a computer programming language such as C++ or Java; or via an appropriate combination of a mathematical programming language and a computer programming language. The fit-for-purpose solution routines may be developed in either mathematical programming languages or directly with a computer programming language or with support of commercially available software tools. For example, commercial and open source versions of mathematical programming languages and computer programming code compilers are generally available.

An exemplary embodiment of uncertainty considerations in robust optimization, with respect to step 120 of FIG. 1, can now be described in detail with reference to FIG. 2. FIG. 2 is a graphical illustration of using the entire uncertainty space associated with data for a reservoir model in accordance with certain exemplary embodiments. The spherical shape represents the uncertainty space 200, which, as discussed above, characterizes uncertainty for information or data that will be considered for planning or decision making The shading within the oval indicates that the full uncertainty space 200 is being considered, rather than just arbitrary data points within the uncertainty space 200. That is, robust optimization allows the entire uncertainty space 200 to be considered for all values deemed possible. With this comprehensive view of uncertainty, robust optimization provides solutions that are closer to the true optimum.

An exemplary embodiment of uncertainty considerations in stochastic programming, with respect to step 120 of FIG. 1, can now be described in detail with reference to FIG. 3. FIG. 3 is an illustration showing a multistage stochastic programming decision tree 300 representing uncertainty associated with data for a reservoir model resolved in several steps and the resolution of the uncertainty over time in accordance with certain exemplary embodiments. The decision tree 300 illustrates a scenario tree with three years and four scenarios. A decision 302 is made at a time T1 based on the information available at the time T1. At a stage 304, uncertainty in some uncertain quantities, for instance oil price, are resolved and a group of decisions 306a, 306b are implemented based on the information available at a time T2. At stage 308a, 308b, uncertainty in uncertain quantities are again resolved and a group of decisions 310a, 310b, 310c, 310d are implemented based on the information available at a time T3.

An exemplary embodiment of uncertainty considerations in Markov decision process, with respect to step 120 of FIG. 1, can now be described in detail with reference to FIG. 4. FIG. 4 is an illustration of a Markov decision process representing uncertainty associated with data for a reservoir model resolved in several steps and the resolution of the uncertainty over time in accordance with certain exemplary embodiments. The Markov decision process 400 illustrates a model with three stages 410 and four states 420 per stage 410. The stages 410 represent the time horizon, the states 420 are used to represent the possible states of the system in the corresponding stage. The actions (not shown) represent the decision variables, and the transition probabilities 450 are based on the data probability distributions. These transition probabilities represent the uncertainty in the data. Although three stages and four states are illustrated in this Markov decision process, any number of stages and states may be possible without departing from the scope and spirit of the exemplary embodiment.

According to FIG. 4, at stage T=1 412, the system may be in a first state 422, a second state 424, a third state 426, or a fourth state 428. At stage T=2 414, the system may be in a fifth state 430, a sixth state 432, a seventh state 434, or an eighth state 436. At stage T=3 416, the system may be in a ninth state 438, a tenth state 440, an eleventh state 442, or a twelfth state 444. FIG. 4 shows the resolution of uncertainty over time when the initial state is at the first state 422.

When the initial state of the system is at stage T=1 412 and the first state 422, the system can transition to the fifth state 430 based upon a first transition probability 452, the sixth state 432 based upon a second transition probability 454, the seventh state 434 based upon a third transition probability 456, or the eighth state 436 based upon a fourth transition probability 458. The transition probabilities 450 could depend on the proposed action to be taken. Additionally, the number of transition probabilities is equal to the number of future states at stage T=2 414. The transition probabilities may range from 0% to 100%. According to some of the embodiments, the transition probabilities are greater than zero, but less than one hundred percent.

When the state of the system is at stage T=2 414 and the fifth state 430, the system can transition to the ninth state 438 based upon a fifth transition probability 460, the tenth state 440 based upon a sixth transition probability 462, the eleventh state 442 based upon a seventh transition probability 464, or the twelfth state 444 based upon an eighth transition probability 466. The transition probabilities 450 could depend on the proposed action to be taken. Additionally, the number of transition probabilities is equal to the number of future states at stage T=3 416. The transition probabilities may range from 0% to 100%. According to some of the embodiments, the transition probabilities are greater than zero, but less than one hundred percent.

However, if the system is at stage T=2 414 and the sixth state 432, the system can transition to the ninth state 438 based upon a ninth transition probability 468, the tenth state 440 based upon a tenth transition probability 470, the eleventh state 442 based upon an eleventh transition probability 472, or the twelfth state 444 based upon a twelfth transition probability 474. The transition probabilities 450 could depend on the proposed action to be taken. Additionally, the number of transition probabilities is equal to the number of future states at stage T=3 416. The transition probabilities may range from 0% to 100%. According to some of the embodiments, the transition probabilities are greater than zero, but less than one hundred percent.

Thus, according to one embodiment, a decision-maker's ultimate objective may be to be at stage T=3 416 and the ninth state 438. If the decision-maker is starting at stage T=1 412 and the first state 422, the decision-maker may desire to proceed from the first state 422 at stage T=1 412 to the ninth state 438 at stage T=3 416, via the fifth state 430 at stage T=2 414. The decision-maker believes that certain actions will facilitate that progress based upon the transition probability 450, which contains the uncertainties. However, due to the uncertainties, the decision-maker may instead proceed to the sixth state 432 at stage T=2 414 from the first state 422 at stage T=1 412. At the sixth state 432, stage T=2 414, the decision-maker may undertake corrective actions so that the decision-maker may attempt to proceed to the ninth state 438 at T=3 416. Although two examples have been provided for reaching the ninth state 438 at stage T=3 416, many pathways may be available for reaching the final objective, ninth state 438 at stage T=3 416, without departing from the scope and spirit of the exemplary embodiment. Additionally, although the final objective has been described to be the ninth state 438 at stage T=3 416, the final objective may be any other state at any future stage without departing from the scope and spirit of the exemplary embodiment. Furthermore, although it has been shown that the first state 422 may progress to the ninth state 438, any initial state at stage T=1 412 may progress to any final state at stage T=3 416, based upon the actions taken and the transition probabilities.

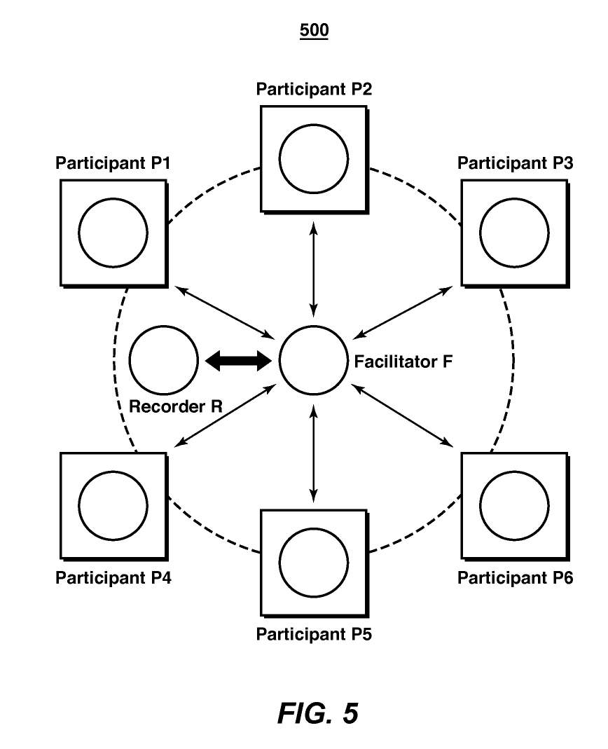

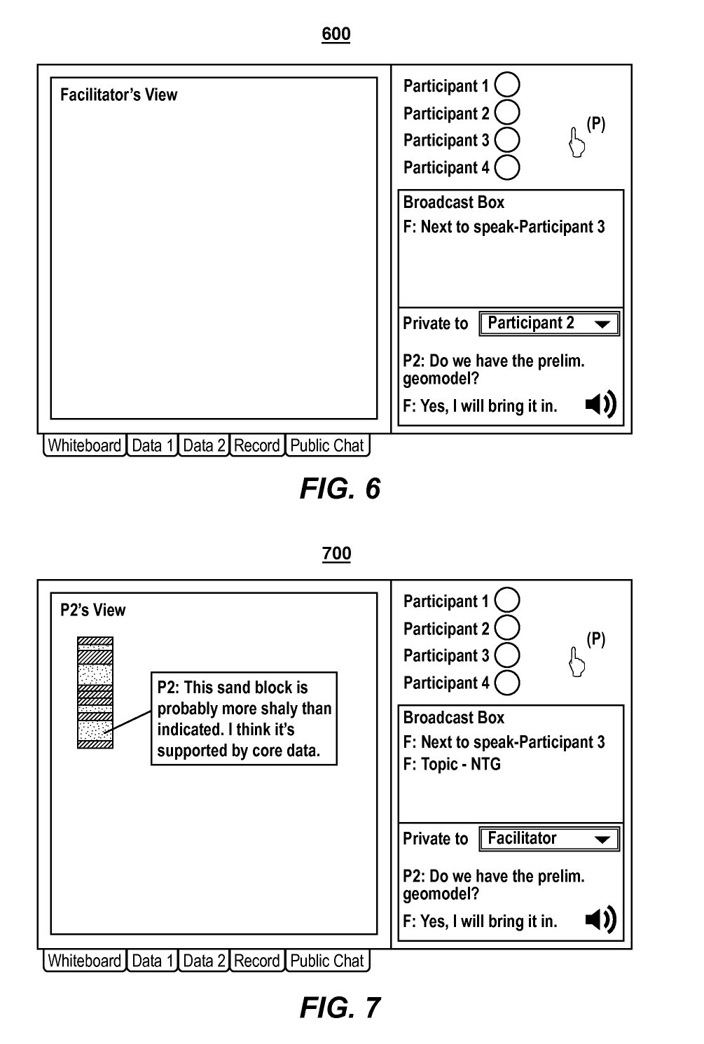

It is understood that variations may be made in the foregoing without departing from the scope and spirit of the invention. For example, the teachings of the present illustrative embodiments may be used to enhance the computational efficiency of other types of n-dimensional computer models. In addition, the aforementioned virtual Delphi method may be incorporated as follows into one or more of the aforementioned methods. For example, referring to FIGS. 5-7, the virtual Delphi environment combines collaborative advantages of a workshop environment while ensuring that dissenting opinion is accounted for before final determination of uncertainties and ranges are made. FIG. 5 is a schematic view of an exemplary system 500 for soliciting input from a panel of experts P1-P6 through a recorder R and a facilitator F. FIG. 6 is an exemplary screenshot of a whiteboard view 600 from a facilitator's F perspective within a virtual Delphi environment. FIG. 7 is a an exemplary screenshot of a whiteboard view 700 from a participant's P2 perspective within a virtual Delphi environment. Referring to FIG. 5, there are three main parties in a preferred embodiment- participants P, facilitator F, and recorder R. Although the environment depicted for system 500 is a computer-aided system, e.g., wherein each participant, facilitator, recorder are connected through various communication channels facilitated through a network, the system 500 shown also represents a system 500 that may be facilitated without a communications network. For example, the facilitator and recorder may simply visit each of the participants P separately and/or in a manner that preserves the anonymity of the participants P between participants P.

Referring to FIGS. 5-7, the facilitator's F and recorder's R identities would be known to all and should be situated within the same room. All participants P would be able to see and hear the facilitator F, as the facilitator F is responsible for ensuring that all opinions are accounted for and/or to mediate discussions. Each participant P is assigned an avatar, e.g., Participant1 P1, Participant2 P2, Participant3 P3, Participant4 P4. Referring to FIG. 5, the participants P1-P6 are shown in indirect communication with each other, e.g., dashed lines, and direct communication with the facilitator F (solid lines). The active participant P may be emphasized on each screen, e.g., with bold-faced type or highlighting to notify all participants P, facilitator F, and/or recorder R of who is currently leading the discussion. Various dialogue boxes are provided which allow the participants to view global messages shared by the group and/or private messages shared between users designated through a pull-down menu, e.g., Facilitator F in FIG. 6 and Participant2 (P2) in FIG. 7. Referring to FIGS. 6 and 7, each screen may include multiple tabs for actively viewing a variety of data and/or conversations, e.g., a whiteboard, data1, data2, record or conversation history, and public chat.

The facilitator F may also serve as the central communication conduit, e.g., responsible for gathering all relevant data, background information before the meeting, and/or deciding which participant P1-P4 should be called upon, e.g., if hesitancy is detected by the facilitator F. Referring to FIG. 6, the facilitator F can see and hear all of the participants P1-P4 and can deliberately designate participants as being the active participant P within a chat room enabled with a commonly visible whiteboard. Alternatively, participants P1-P4 may request the floor, e.g., effectively “raise their hands,” by prompting the facilitator, through an instant message to the facilitator F or other visual or audio signal, to queue the participant(s) to avoid confusion and enable roundtable discussions in an orderly manner.

Referring to FIG. 7, all participants P1-P4 would be able to see and hear the recorder R, however the recorder R would not normally be an active participant in a discussion. The primary purpose of the recorder R is to record notes that would be immediately visible to all. This allows the facilitator F to freely move the discussion and not be tied up with note-taking Alternatively, the recorder R may be replaced with a chat room history, e.g., all conversations can be stored and queued for later viewing and/or for selective display in the chat room or whiteboard, e.g., controlled by the facilitator F and/or one or more of the participants P on their individual screens. Participants P may be portrayed anonymously, e.g., individual screens of each of the participants P1-P4, e.g., P1, may only include anonymous avatars representative of the other participants, e.g., P2-P4, e.g., such as color-coded symbols, text designations such as P2-P4, or unique avatars. In contrast, the recorder R and/or facilitator's screens would show the individual identities of each participant P1-P4 only to the recorder or facilitator F, while preserving anonymity between participants. Inter-participant discussion would always be limited to anonymous discussions conducted through the chat room and/or whiteboard. In addition, additional tabs may be provided for storing a variety of background information, e.g., such as high-speed and/or high fidelity reservoir models relevant to the discussion topic.

Factors and ranges, e.g., while discussing uncertainty, can be discussed through the chat room and/or whiteboard (with participant annotations such as shown in FIG. 7). Rankings and polling from participants P1-P4 may be collected in an orderly fashion, with dissenting opinions being voiced and recorded while maintaining the anonymity of the participant P1-P4. Accordingly, bias from stronger, more senior, or more authoritative voices may be heard without any special emphasis on the source, thereby encouraging a rapid, free flowing exchange of ideas and opinions in an orderly manner.

Although illustrative embodiments have been shown and described, a wide range of modification, changes and substitution is contemplated in the foregoing disclosure. In some instances, some features may be employed without a corresponding use of the other features. Accordingly, it is appropriate that the appended claims be construed broadly and in a manner consistent with the scope and spirit of the disclosure.

What is claimed is:

1. A method for optimizing reservoir performance for a reservoir containing hydrocarbons, comprising the steps of:
(a) identifying a reservoir related objective;
(b) characterizing uncertainty contributing to the reservoir related objective, wherein characterizing uncertainty of the objective comprises determining decision variables and uncertainty variables associated with the objective;
(c) analyzing the determined uncertainty variables and integrating the uncertainty variables with a baseline model related to the reservoir related objective to output a modified model incorporating uncertainty;
(d) incorporating the determined decision variables with the modified model, and optimizing the decision variables to produce optimized model results; and
(e) providing the optimized model results as feedback to the baseline model, wherein the optimized model results are compared with results output from the baseline model to determine consistency of results from each model or for reevaluating the baseline model.

2. The method of claim 1, wherein the reservoir related objective comprises an estimate of static reservoir characterization of the reservoir, or a prediction of dynamic reservoir performance.

3. The method of claim 1, wherein the reservoir related objective comprises one or more scenarios relating to reservoir development planning, one or more scenarios relating to reservoir evaluation, or one or more scenarios relating to reservoir management.

4. The method of claim 2, wherein the reservoir related objective is associated with surface facilities related to the reservoir.

5. The method of claim 1, further comprising iteratively repeating steps b) through e), if the results from the baseline model and the optimized model are not consistent, based on the optimized model results.

6. The method of claim 1, wherein analyzing the determined uncertainty variables comprises using at least one of a response surface model, a probability distribution function model, or a combination thereof, to create at least one proxy model or at least one probability distribution function model which retains model performance and model characteristics in the modified model.

7. The method of claim 1, wherein the baseline model is a relatively fine model and the modified model is a relatively coarse model.

8. The method of claim 1, wherein the baseline model is a high fidelity model and the modified model is a higher speed representation of the high fidelity model.

9. The method of claim 1, further comprising:
obtaining input regarding a plurality of factors relevant to the reservoir related objective;
based on the input, characterizing some of the plurality of factors as decision variables and other of the plurality of factors as uncertainty variables; and
providing output relevant to completing the reservoir related objective in response to processing the decision variables and the uncertainty variables via a computer-based routine.

10. The method of claim 9, wherein the step of obtaining input comprises conducting a Delphi method, including determining factors and ranges relevant to the reservoir development objective via the Delphi method.

11. The method of claim 9, wherein obtaining input comprises obtaining input from a panel of experts.

12. The method of claim 11, wherein the step of obtaining input comprises:
obtaining an opinion from each expert from the panel of experts; and
soliciting feedback from each of the experts regarding the obtained opinions, while maintaining anonymity of each obtained opinion.

13. The method of claim 9, wherein processing the decision variables and the uncertainty variables via the computer-based routine comprises generating a response surface model associated with the uncertainty variables via a design-of-experiment technique.

14. The method of claim 9, wherein processing the decision variables and the uncertainty variables via the computer-based routine comprises generating a distribution function model associated with the uncertainty variables via Bayesian Belief Networks.

15. The method of claim 9, wherein processing the decision variables and the uncertainty variables via the computer-based routine comprises optimizing via computer-implemented robust optimization at least some aspect of a reservoir development plan based on at least one data parameter and an uncertainty space.

16. The method of claim 9, wherein processing the decision variables and the uncertainty variables via the computer-based routine comprises optimizing via stochastic programming.

17. The method of claim 9, wherein the computer-based routine comprises a Markov decision process.

18. The method of claim 1, further comprising:
formulating a reservoir development plan based on the optimized model results; and
developing hydrocarbon resources from the reservoir according to the reservoir development plan.

19. A method for determining reservoir performance, comprising the steps of:
characterizing uncertainty related to reservoir development into decision variables and uncertainty variables based on input from a panel of experts;
analyzing the uncertainty variables using a reservoir model to construct proxy models; and
optimizing the decision variables and the proxy models via one of computer-implemented robust optimization, stochastic programming, and a Markov decision process.

20. The method of claim 19, further comprising mitigating bias of the panel of experts.
